(19) United States
(12) Patent Application Publication
(10) Pub. No.: US 2020/0358294 A1
(43) Pub. Date: Nov. 12, 2020

(54) Everlasting Battery

(71) Applicant: Haritha Atmakuri, Phoenix, AZ (US)

(72) Inventor: Haritha Atmakuri, Phoenix, AZ (US)

(21) Appl. No.: 16/405,579

(22) Filed: May 7, 2019

(51) Int. Cl. H02J 7/00; H01M 2/10; H01M 10/44; H01M 10/48

(52) U.S. Cl. CPC H02J 7/007; H01M 10/48; H01M 10/44; H01M 2/1016

(57) ABSTRACT

Everlasting Battery device or system is energy storage and distribution by measured activity that will have doubled efficiency and fastest recharges.

Energy by Measured Activity is deriving the predetermined energy flows to perform intended activity in a given environment and time period. In this case it is deriving the quantity of energy carrier based on predetermined required amount of power consumption.

In the real world use, Everlasting Battery can be applied for electronic devices, machinery/equipment, transportation, utility power storage and distribution. The scale has huge spread and fits well into renewable energy initiatives of this era.

Everlasting Battery has 2 main parts. Technology aspect of AntiAging flows and design aspects of independent modules connected for efficient power distribution and accumulation. Energy by measured activity is the fundamental mechanism that determines the power and output of the battery and it's parts.

### BACKGROUND OF INVENTION

### Field of Invention

This invention pertains to Clean Energy application of storage and consumption and specifically applied to battery devices with variable throughputs and physical forms intended for predetermined measured activity of energy requirements by consumption with doubled life, efficiency and fastest recharges.

### Description of Prior Art

Existing electrical batteries loose 25% of battery life every year for aging. There is additional loss of life for accumulated partial charges. That is significant loss of battery life due to aging and limitations of charge flows. There is no measurable means to quantify battery consumption at this time by specific activity and distance to affect viable battery applications for real world use.

The problems solved are on 2 fronts. Technology and Environment. The primary aspects are:

1. Long Lifespan

2. Anti-aging

3. Measured Recharge Timespan

4. Fastest Recharges

5. Precise & Accurate

6. Clean Energy

Technology Front

Lifespan of battery will be significantly increased with anti-aging electric flows alternating electric potential. It will decrease the corrosive nature of a battery. As a result measured life of a battery based on predetermined activity and energy required can be accomplished.

Recharges at this time have several limitations from need to drain battery to loosing charge faster with age and corrosiveness. All these are resolved with Anti-Aging flows. Faster recharges are accomplished with Add-Ons and effective energy storage flows and layouts.

Quantifying energy in all forms is one aspect and transformation into other forms that affect the processes and results in physical changes of that environment is another. It is feasible with one equation to measure energy in all its forms for precise, repeatable and accurate outcomes. From generation of energy to distribution through grid can be precisely quantified by distance or predetermined activity removing the guess work out of the process.

Environment Front

Everlasting Battery with its scale from micro electronic devices to utility storage and distribution, Add-On extensibility and confirming to any predetermined measured activity opens up to several new applications that had not been feasible before this invention.

For energy storage and use, it's completely Carbon Free and will spearhead and revolutionize clean energy initiatives in all forms. Carbon Free consumption and its vast benefits will outweigh the material mining and carbon footprint on supply side for manufacturing.

### SUMMARY OF THE INVENTION

Anti-Aging Flows

There is energy loss irrespective of activity in batteries limiting the age of battery devices. There are several reasons for aging and the significant loss is due to following:

1. Surface Friction

2. Corrosion

3. Movement of ions

4. Stagnation

During one sided directional flow of ions in an electric potential, few ions will be stuck and held back due to surface friction of enclosing material over a period of time. This contributes to aging of battery and also necessity for draining the battery 100% before recharging. Alternating flows will give stuck charged ions additional force of attracting energy to gain momentum contributing to smoother flows and reducing the corrosive nature of stagnant electrochemical and maintaining continuous movement of ions.

Corrosion of electrochemical will occur when latent heat in the environment excites ions beyond threshold to escape reducing the quantity of electrochemical available contributing to aging process. Therefore, heat escape routes in the battery device to release heat as necessary will significantly increase battery life. Anti-aging flows will reduce corrosive energy due to alternating electric potentials creating movement of charged ions.

Accumulated charged ions occupies the space and limits the battery functioning to partial usage where there is free movement and flows of electrochemical carrying the charge. This contributes to aging process and be contained by anti-aging flows for more effective use of battery.

Stagnation of charged ions in electrochemical will corrode the enclosed material and contributes to leaks of electrochemical carrier over a period of time resulting in defective battery devices. Anti-aging flows will facilitate smooth flows deterring the stagnation of ions increasing the life of batter significantly.

The charged connectors on all sides facilitate 2 functions. One to orchestrate the alternating electric flows and second to link and stack multiple cells together to make a coherent battery device or system.

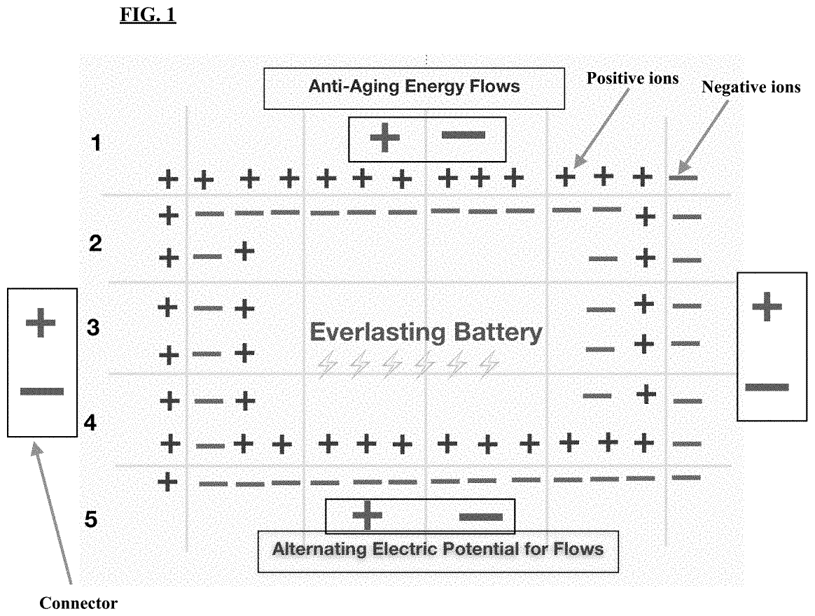

See FIG. 1 for visual representation of battery device with anti-aging flows.

Add-On Cell Energy Storage

The primary drivers for most effective variable energy storage, retrieval and distribution mechanisms are as follows:

1. Mobility

2. Speed

3. Space optimization

4. High Density

5. Minimize failure

6. Failover mechanisms

7. Ease of Distribution

8. Life Span

9. Scale

These are accomplished by a self sufficient, independent Add-on battery cells or modules that can be connected together to function as a cohesive, interconnected singular unit that is flexible to meet various energy requirements for storage and distribution.

To achieve scale for mobile devices the primary priorities are mobility, space, and life of battery between recharges. While ease of distribution, power, speed and failure mechanisms are more preferred in machinery, vehicles and utility level services of storage and retrieval.

To accommodate and meet the requirements for any application of this technology single extendable Add-On units driven by algorithms will give flexibility and all required aspects for end products.

Single battery Module has predefined output and can function independently or connected to modules of other singular modules. It is a unit of power storage in a self sufficient module that can be added to other modules and replicated as needed.

There are several ways Add-On layouts can be organized for an efficient and effective solution depending on space and mobility requirements.

Layout patterns will define the arrangement and connectivity of modules with relevant algorithms driving the electric flows of battery. There are 2 different types of layouts for Add-On modules and several patterns of arrangements are possible based on requirements. These are:

1. Links that are horizontal Add-Ons and

2. Stacks that are vertical Add-Ons

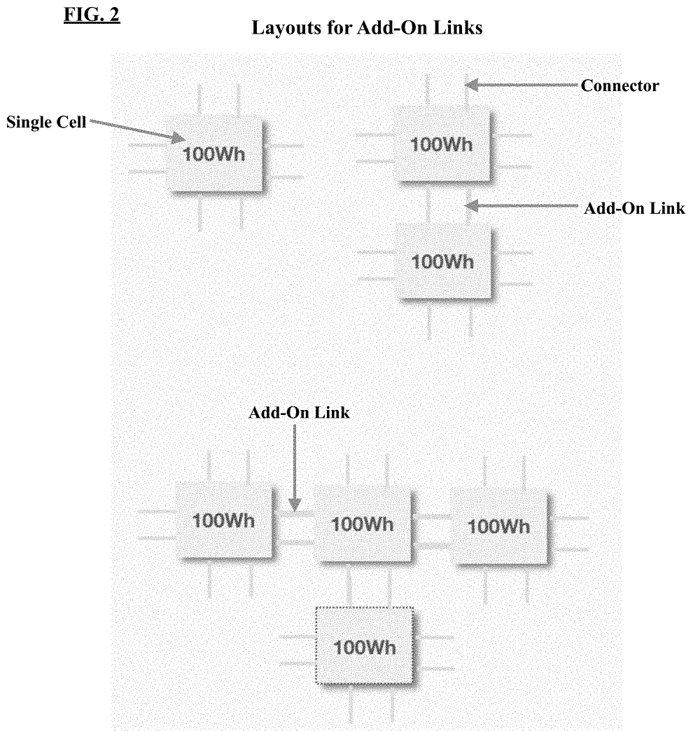

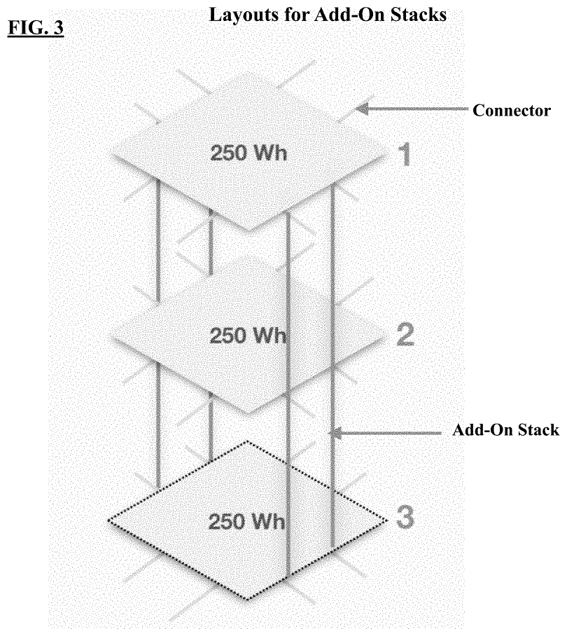

See FIG. 2 and FIG. 3 for visual representation of Add-On links and Add-On stacks

Layouts

The layout patterns are not only flexible in physical arrangement of cells but also have significance in determining type of directional anti-aging electric flows.

The 2 different types of electric flows for faster recharges and determining the electric potential sources are as follows:

1. Gravity Flows

2. EdgeIn Flows

Gravity Flows

Gravity flows are suitable for stacks vertical layouts as it in the direction of gravitational energy flowing downwards adding the momentum of ions when sufficient voltage is induced. As many electric potential sources can be introduced on the top level as space permits.

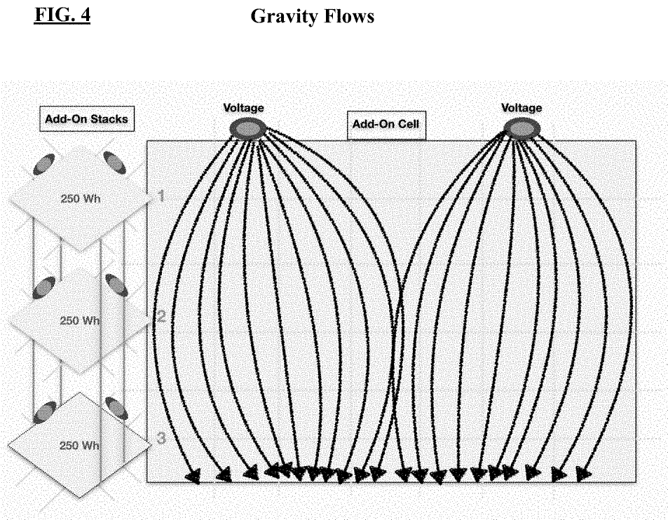

See FIG. 4 depicting the gravity flows of electric ions in a stacked battery.

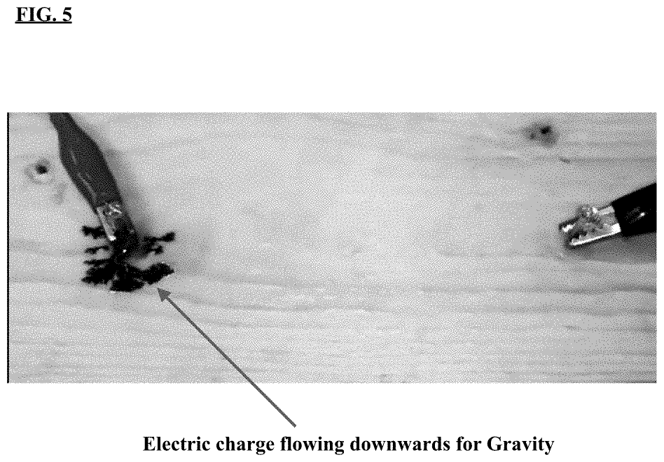

Real world example in nature validating Gravity flows is in fractal wood burning with electricity. See FIG. 5 showing the path and traces of electric flows downwards in burning wood.

EdgeIn Flows

EdgeIn flows are more suited for links horizontal layouts meeting a center point from opposite ends and the speed of the ions can be modulated by inducing voltages. As many electric potential sources can be used on both edges to meet the requirements

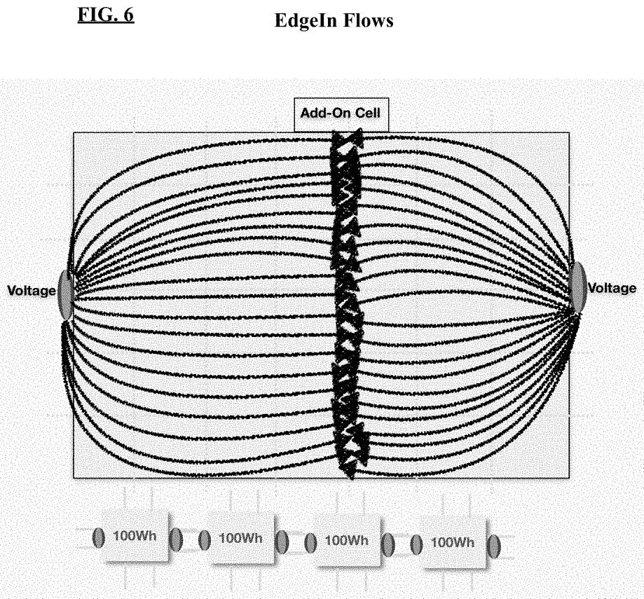

See FIG. 6 depicting the EdgeIn flows of electric ions in a stacked battery.

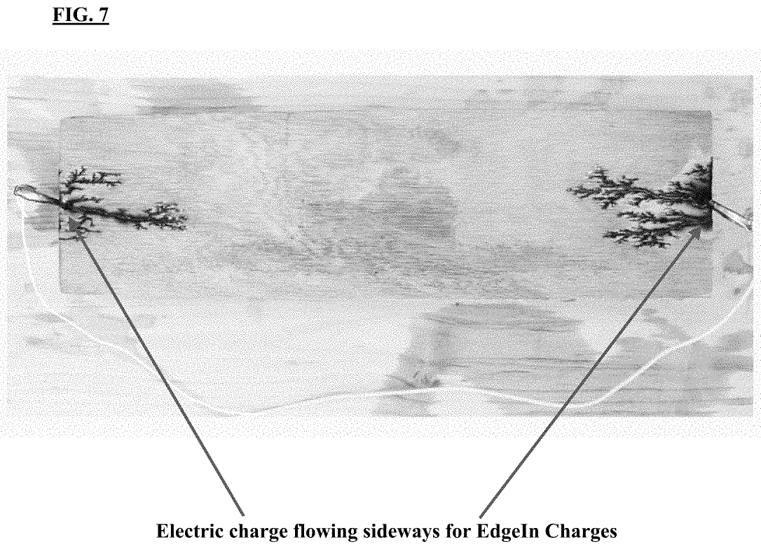

EdgeIn flows are validated in fractal wood burning with electricity shown in FIG. 7. It depicts the path and traces of sideways electric flows when induced on both ends.

Materials

The choices that are required for materials are primarily dependent on the environment and conditions that battery has to be integrated and function in. The variables that have to be considered are as follows:

1. Electrochemical properties,

2. Heat accumulation and release,

3. Weight, and

4. Application

Electrochemical properties that are required are high density of energy storage and high usage capacity within the chemistry of the carriers. Lithium-ion has the highest energy and power density compared to other materials. The free flow of ions is dependent on viscosity of the carrier, movement friction and reactivity against the enclosing material.

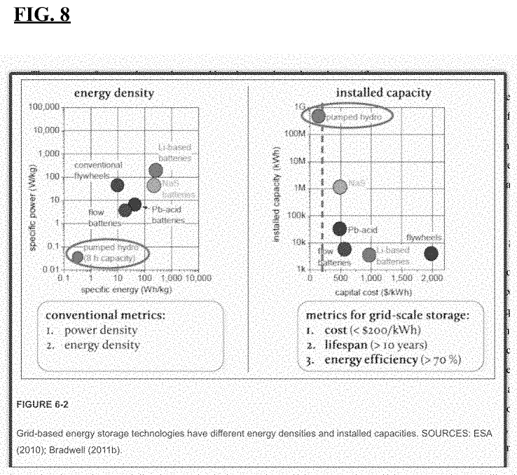

See FIG. 8 depicting the density comparisons for various electric carriers.

Casing

The casing for battery materials will have to be light weight and facilitate heat flows effectively while less reactive in changing the physical form to surrounding elements.

Electrochemical corrodes and escapes when latent heat excites the ions beyond the threshold depleting the electrochemical. Therefore the casing will have to absorb excess heat and release it at a slower pace by expanding and contracting as necessary. Casing material will have to be malleable and non-corrosive to accommodate these requirements.

In the enclosure casing heat escape routes will increase the life of battery as well.

Weight of material is application dependent as lightweight materials are of utmost priority in mobile devices while machinery, vehicles and heavy equipment can accommodate heavier materials to withstand harsh industrial conditions.

For effective results, alloys of titanium and aluminum with fiberglass layering will be used for handheld and smaller devices.

Energy Science

“Its all about our place in cosmos. Big, small and everything in between”

The conclusive discovery of Theory of Everything that unified the underlying fundamental reasoning for nature formation, behavior and transformation has given the ability to quantify change precisely. This applies to all encompassing behavior in universe from tiniest particles to cosmic elements and everything in between.

Energy is the primary source that organizes and orchestrates shifts in life and nature that drives change and defines its final form, shape and characteristics in a given environment. The formulation of singular, concrete mathematical function to quantify energy for big, small and everything in between with common fundamental behavior that can be replicated over and over again producing same expected results has given immense power to humanity. This understanding have paved path to well defined scientific method to further advancements in many facets of life.

Everlasting Battery is one such modular platform built for effective energy storage, consumption and distribution with this understanding of energy science and breakthrough innovations in quantified energy transformations.

There are 2 ways to quantify energy.
1. Energy by Distances is mechanism that quantifies energy required to reach known distances
2. Energy by Measured Activity is mechanism that modulates the impacted variables to achieve predetermined energy goal

Everlasting Battery is built on energy by measured activity.

Energy by Measured Activity

Measuring and knowing the end goal and energy required to achieve that is in precise and quantified energy transformations and variables that impact the environment of these transformations.

For devices measured energy is for a battery life in a given timespan before recharge. For transportation vehicles it is number of miles or distance it has to reach with single charge. For utilities it is storage density, capacity, to distances to be traveled in distribution grids. All these energy transformations can be predetermined and calculated at every transformation sources and affect the outcomes at the destinations using singular mathematical function, Nature Key.

The Nature Key

Nature Key is the single mathematical equation to quantify all encompassing behavior and laws that govern our universe and beyond. This complex knowledge is derived from my single theory of nature and laid a pathway to unified reasoning for cosmology, quantum mechanics and everything else that lie in our physical world. Harnessing the understanding of common fundamental behavior and the power to quantify is compelling path to solving entrenched problems for better in every aspect of life and the physical world we are surrounded by and living in.

There are 2 parts to binding energy in a given environment. One is energy needed to navigate the environment and second is energy needed to hold in place of balance at a certain distance from surrounding objects that have neighborhood effect on it.

Eg=Eenv+Edist

Given environment is the medium in which energy transformations occur resulting in physical and electrochemical changes. Pressure, volume and speed are the impacted variables. This includes opposing forces as well.

Eenv=P*V*c²

P=Pressure in a given environment for movement of ions

V=Volume of given electrochemical

c=Speed of electrochemical flow for a given viscosity

The distance between objects and speed are variables for energy needed to hold in balance.

Edist=d*c²

d=distance between objects (source to destination)

c=speed of ion movement

The binding energy required can be obtained for known distances.

Eg=PVc²+dc²—Nature Key

Binding energy Eg is the amount needed for predetermined behavior and changes in a given environment.

Battery Energy

A singular battery module or cell has series of energy creations and transformations that are self sufficient to drive intended activities and applications.

These energy forms and transformations include:

1. Energy to charge with sufficient electric potential

2. Energy by predetermined activity for a time span or distance to be traveled

3. Energy for storage capacity

4. Energy for consumption and distribution

Electric Potential

The energy required to create sufficient electric potential for fastest recharges can be calculated as follows:

Eg=PVc²+dc²

P=Pressure in a given environment for movement of ions

V=Volume of given electrochemical

c=Speed of electrochemical flow for a given viscosity

d=length and size of the enclosure

c=speed of ion movement

Necessary voltage can be obtained from Eg as follows:

Volts(v)=Eg/Qc

where

Qc=charge in number of coulombs

Applications

Energy by measured activity is calculated by power consumption of the devices in an hour or for a given timespan. Using this predetermined energy the volume of electrochemical based on its density can be obtained. Precise and effective measure to implement single or multiple Add-On modules to create necessary energy storage. Similar calculations will be used for quantifying capacity with required volume of electrochemical to be stored. For distribution of electricity via grid, the amount of energy needed to reach certain distance from source can be accurately calculated.

Links and stacks layouts will coordinate the space arrangements for devices, machinery, transportation vehicles and utilities.

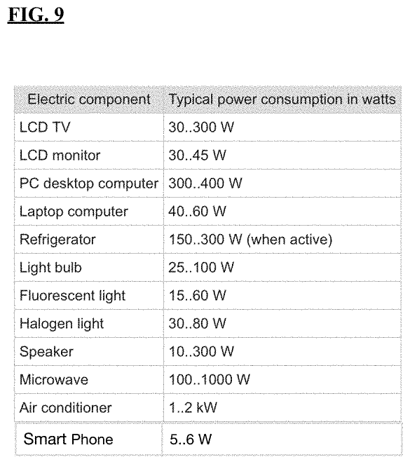

Power Consumption of electric components most in use are depicted in FIG. 9.

In Perspective
1. Carbon Free vehicles will be norm
2. Charge & Go electric fastest recharge stations infrastructure same as gas stations
3. 100% Electric Airplanes will be norm
4. Cross-country road trip in electric car with one battery charge at start
5. Once a year Smart Phone recharges
6. Clean Energy storage/distribution at any establishment, high and low capacities
7. Utility scale battery distribution centers will facilitate energy storage, distribution and consumption via connected grids

1: A battery device or system with mechanisms for Anti-Aging flows that consists of:
a. Both positive (+) and negative (−) connectors on all sides of a single cell
b. Alternating charge flows in the system
c. Mechanisms to link multiple cells together
d. Mechanisms to stack multiple cells together
e. Mechanisms to extend alternating charge flows to connected cells

2: A battery device or system of claim 1 with mechanisms for fastest recharging that consists of:
a. Mechanisms to induce charge flows downwards as in gravity flows, and/or
b. Mechanisms to induce charge flows sideways as in EdgeIn flows
c. Mechanisms to induce measured electric voltage for full charge predetermined by certain time

3: A battery device or system of claim 1 with activity based measured energy transformations consisting of:
a. Energy to charge with sufficient electric potential
b. Energy by predetermined activity for a time span or distance to be traveled
c. Energy for storage capacity
d. Energy for consumption and distribution

4: A battery device or system of claim 1 applied in:
a. External battery device as source of energy or power for mobile devices
b. Internal battery device as source of energy or power for mobile devices
c. External battery device as source of energy or power for electronic devices
d. Internal battery device as source of energy or power for electronic devices
e. External battery device as source of energy or power for tools, machinery or equipment
f. Internal battery device as source of energy or power for tools, machinery or equipment
g. External battery device as source of energy or power for transportation vehicles
h. Internal battery device as source of energy or power for transportation vehicles
i. External battery device as source of energy or power for utility or energy storage devices
j. Internal battery device as source of energy or power for utility or energy storage devices
k. External battery device as source of energy or power for utility or energy distribution mechanisms
l. Internal battery device as source of energy or power for utility or energy distribution mechanisms
m. External battery device as source of energy or power for electric charging stations
n. Internal battery device as source of energy or power for electric charging stations
